(19) United States
(12) Patent Application Publication
(10) Pub. No.: US 2026/0166694 A1
(43) Pub. Date: Jun. 18, 2026

(54) Engaging Structure for Hand Tool

(71) Applicant: Chia-Kuan Liao, Taichung City (TW)

(72) Inventor: Chia-Kuan Liao, Taichung City (TW)

(21) Appl. No.: 18/981,713

(22) Filed: Dec. 16, 2024

(51) Int. Cl. B25B 23/10; B25B 13/04; B25B 13/06; B25B 13/08; B25B 13/46

(52) U.S. Cl. CPC B25B 23/105; B25B 13/04; B25B 13/065; B25B 13/08; B25B 13/463

(57) ABSTRACT

An engaging structure for a hand tool includes a main body provided with a mounting element including three first drive portions, three second drive portions, and six receiving portions. The first drive portions and the second drive portions are arranged alternately. Each of the receiving portions is arranged between one of the first drive portions and one of the second drive portions. Each of the first drive portions has a first face, a second face, a first intersecting line, a first groove, and a second groove. Each of the second drive portions has a third face. In a two-dimensional view, the mounting element is provided with a first center, a first circle, and a first hexagon. The first face of each of the first drive portions is tangent to the first circle and coincides with one of the sides of the first hexagon.

### BACKGROUND OF THE INVENTION

### Field of the Invention

The present invention relates to an engaging mechanism or a socket and, more particularly, to an engaging structure for a hand tool.

### Description of the Related Art

A conventional engaging structure for a hand tool was disclosed in

the U.S. Publication No. 2007/0125204, and comprises a socket 20 having an engaging hole 22, six grooves 23, and six stop ribs 24.

However, such a conventional engaging structure for a hand tool has the following disadvantages.
1. When the socket 20 drives the screw head 40, the stop ribs 24 are locked on the six sides of the screw head 40, to rotate the screw head 40. The stop ribs 24 protrude in the engaging hole 22 to an extent, and a large interval is defined between the groove 23 of the engaging hole 22 and the angled corner of the screw head 40 so that the engaging hole 22 cannot easily rub the angled corner of the screw head 40. But, the socket 20 needs to have a determined thickness to keep the rotation force and torque, so that the outer diameter of the socket 20 is increased due to projection of the stop ribs 24.
2. Each of the stop ribs 24 has a sharp pointed shape so that the rotation torque is not large enough. Thus, the screw head 40 is easily worn out or chamfered by the stop ribs 24 during a period of time.
3. When the socket 20 is used to rotate the screw head 40, the stop ribs 24 engage the screw head 40 successively and easily cause a serration on the screw head 40.

### BRIEF SUMMARY OF THE INVENTION

The primary objective of the present invention is to provide an engaging structure that is available for driving a screw member that is worn out or rounded.

In accordance with the present invention, there is provided an engaging structure for a hand tool, comprising a main body provided with a mounting element. The mounting element includes three first drive portions, three second drive portions, and six receiving portions. The three first drive portions and the three second drive portions are arranged alternately and annularly. Each of the six receiving portions is arranged between one of the three first drive portions and one of the three second drive portions. Each of the three first drive portions includes a first face, a second face, and a first intersecting line. Each of the three first drive portions is provided with a first groove and a second groove. Each of the three second drive portions is provided with a third face. In a two-dimensional view, the mounting element is provided with a first center, a first circle, and a first hexagon. The first face of each of the three first drive portions is tangent to the first circle. The first face of each of the three first drive portions coincides with one of the six sides of the first hexagon.

According to the primary advantage of the present invention, when the main body is rotated clockwise to drive the first screw member, the main body provides a primary driving force and a secondary driving force. When the main body is rotated counterclockwise to drive the first screw member, the main body also provides a primary driving force and a secondary driving force. When the main body is rotated to drive the first screw member whose six sides are worn out and rounded, the first intersecting lines of the three first drive portions lock the three sides of the first screw member to provide a force concentration, so that the mounting element is used to drive and rotate the first screw member that has been worn out. Thus, the mounting element has three rotational modes to drive and rotate the first screw member exactly.

According to another advantage of the present invention, each of the first face, the second face, and the third face has a planar shape, so that the first face, the second face, and the third face will not cause a bite mark on the first screw member during rotation.

According to a further advantage of the present invention, each of the three second drive portions has a traditional structure. Thus, the three first drive portions are added to cooperate with the three second drive portions to facilitate operation of the mounting element.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of an engaging structure for a hand tool in accordance with the preferred embodiment of the present invention.

FIG. 2 is a front view of the engaging structure for a hand tool in accordance with the preferred embodiment of the present invention.

FIG. 3 is a schematic front view of the engaging structure for a hand tool in accordance with the preferred embodiment of the present invention.

FIG. 4 is a front view of a first operation state of the engaging structure for a hand tool in accordance with the preferred embodiment of the present invention.

FIG. 5 is a front view of a second operation state of the engaging structure for a hand tool in accordance with the preferred embodiment of the present invention.

FIG. 6 is a front view of a third operation state of the engaging structure for a hand tool in accordance with the preferred embodiment of the present invention.

FIG. 7 is a front view of a fourth operation state of the engaging structure for a hand tool in accordance with the preferred embodiment of the present invention.

FIG. 8 is a perspective view of an engaging structure for a hand tool in accordance with the second preferred embodiment of the present invention.

FIG. 9 is a perspective view of an engaging structure for a hand tool in accordance with the third preferred embodiment of the present invention.

FIG. 10 is a front view of an engaging structure for a hand tool in accordance with the fourth preferred embodiment of the present invention.

FIG. 11 is a front view of an engaging structure for a hand tool in accordance with the fifth preferred embodiment of the present invention.

FIG. 12 is a front view of an engaging structure for a hand tool in accordance with the sixth preferred embodiment of the present invention.

FIG. 13 is a front view of an engaging structure for a hand tool in accordance with the seventh preferred embodiment of the present invention.

FIG. 14 is a front view of an engaging structure for a hand tool in accordance with the eighth preferred embodiment of the present invention.

FIG. 15 is a front view of an engaging structure for a hand tool in accordance with the ninth preferred embodiment of the present invention.

FIG. 16 is a front view of an engaging structure for a hand tool in accordance with the tenth preferred embodiment of the present invention.

### DETAILED DESCRIPTION OF THE INVENTION

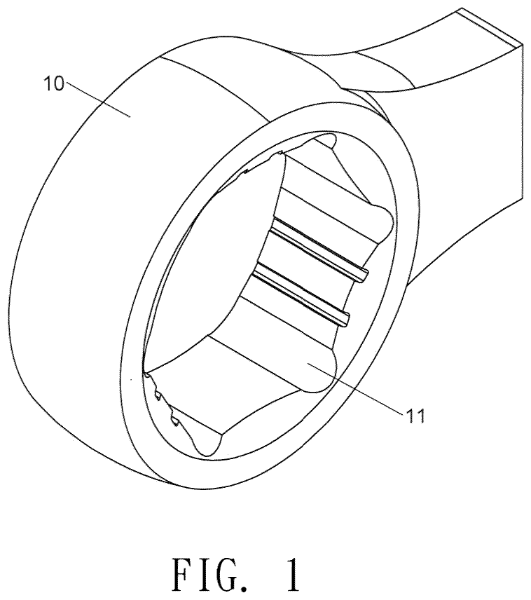

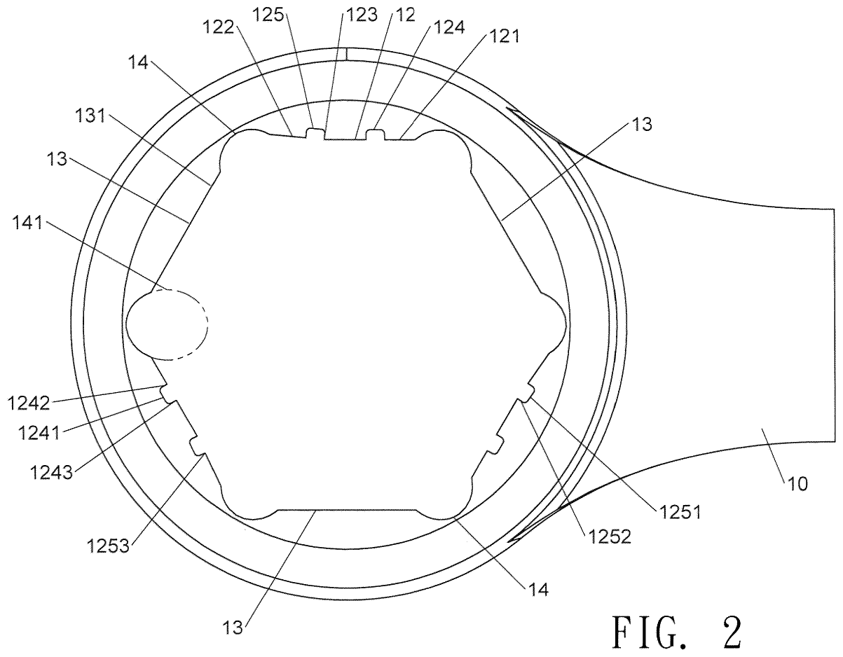

Referring to the drawings and initially to FIGS. 1-3, an engaging structure (or an operating structure or a driving structure) for a hand operated tool in accordance with the preferred embodiment of the present invention comprises a main body 10. The main body 10 is provided with a mounting element 11. The mounting element 11 includes three first drive portions 12, three second drive portions 13, and six receiving portions 14. The three first drive portions 12 and the three second drive portions 13 are arranged alternately and annularly. Each of the six receiving portions 14 is arranged between one of the three first drive portions 12 and one of the three second drive portions 13. Preferably, the main body 10 is a box end wrench or an engaging member of a hand operated tool.

Each of the three first drive portions 12 includes a first face 121 and a second face 122. The first face 121 has a planar shape. The second face 122 has a planar shape. The first face 121 and the second face 122 have an intersection provided with a first intersecting line 123. The first face 121 and the second face 122 intersect at a straight line.

Each of the three first drive portions 12 is provided with a first groove 124 disposed on the first face 121. The first groove 124 has a first side 1241 and two second sides 1242. The first side 1241 and the two second sides 1242 form a U-shaped opening. Each of the first side 1241 has a planar shape, and each of the two second sides 1242 has a planar shape. The first side 1241 is provided on a bottom of the first groove 124. The two second sides 1242 are at two sides of the first side 1241. The first groove 124 and the first face 121 have an intersection provided with two second intersecting lines 1243. The two second intersecting lines 1243 are parallel with each other. The two second intersecting lines 1243 are parallel with the first intersecting line 123.

Each of the three first drive portions 12 is provided with a second groove 125 disposed on the second face 122. The second groove 125 has a third side 1251 and two fourth sides 1252. The third side 1251 and the two fourth sides 1252 form a U-shaped opening. Each of the third side 1251 has a planar shape, and each of the two fourth sides 1252 has a planar shape. The third side 1251 is provided on a bottom of the second groove 125. The two fourth sides 1252 are at two sides of the third side 1251. One of the two fourth sides 1252 coincides with the first intersecting line 123. The second groove 125 and the second face 122 have an intersection provided with a third intersecting line 1253. Thus, the second groove 125 and each of the three first drive portions 12 intersect at the first intersecting line 123 and the third intersecting line 1253. The third intersecting line 1253 is parallel with the first intersecting line 123. The third intersecting line 1253 is parallel with each of the two second intersecting lines 1243.

The second groove 125 has a shape and a structure the same as that of the first groove 124. An interval is defined between the second groove 125 and the first groove 124. The third side 1251 has a size equal to that of the first side 1241. Each of the two fourth sides 1252 has a size equal to that of each of the two second sides 1242.

Each of the three second drive portions 13 is provided with a third face 131 having a planar shape.

Each of the six receiving portions 14 is an arcuate concave face. Each of the six receiving portions 14 is formed with a first ellipse 141. Each of the six receiving portions 14 is not tangent to the first face 121, the second face 122, and the third face 131.

In a two-dimensional view, the mounting element 11 has an axis provided with a first center 15 which constructs a first circle 151. The first face 121 of each of the three first drive portions 12 is tangent to the first circle 151. The first circle 151 forms a first hexagon 152 having six sides. The first face 121 of each of the three first drive portions 12 coincides with one of the six sides of the first hexagon 152. The first center 15 is provided with a first vertical line 153. The first face 121 of one of the three first drive portions 12 is perpendicular to the first vertical line 153. The first face 121 of one of the three first drive portions 12 intersects the first vertical line 153 and is located on two sides of the first vertical line 153 respectively. The first groove 124 is arranged at a first side of the first vertical line 153, and the second face 122, the first intersecting line 123, the third intersecting line 1253, and the second groove 125 are arranged at a second side of the first vertical line 153. The first hexagon 152 has six first angled corners 154. Each of the six receiving portions 14 is situated outside of one of the six first angled corners 154.

A first distance 155 is defined between two of the six sides of the first hexagon 152. A first angle 156 is defined between the second face 122 and the first face 121. The first angle 156 is less than 15° or the first angle 156 is ranged between 5° and 10°. Each of the six sides of the first hexagon 152 defines a second distance 157. A third distance 158 is defined between the first intersecting line 123 and one of the six first angled corners 154. A fourth distance 159 is defined between the first intersecting line 123 and another one of the six first angled corners 154. The third distance 158 plus the fourth distance 159 is equal to the second distance 157. A ratio of the third distance 158 and the fourth distance 159 is 6:4 or close to 6:4. A second angle 1591 is defined between the first face 121 and one of the two fourth sides 1252. The second angle 1591 is less than 180°. A fifth distance 1592 is defined between the third face 131 and one of the six sides of the first hexagon 152. The fifth distance 1592 is equal to zero so that the third face 131 coincides with one of the six sides of the first hexagon 152.

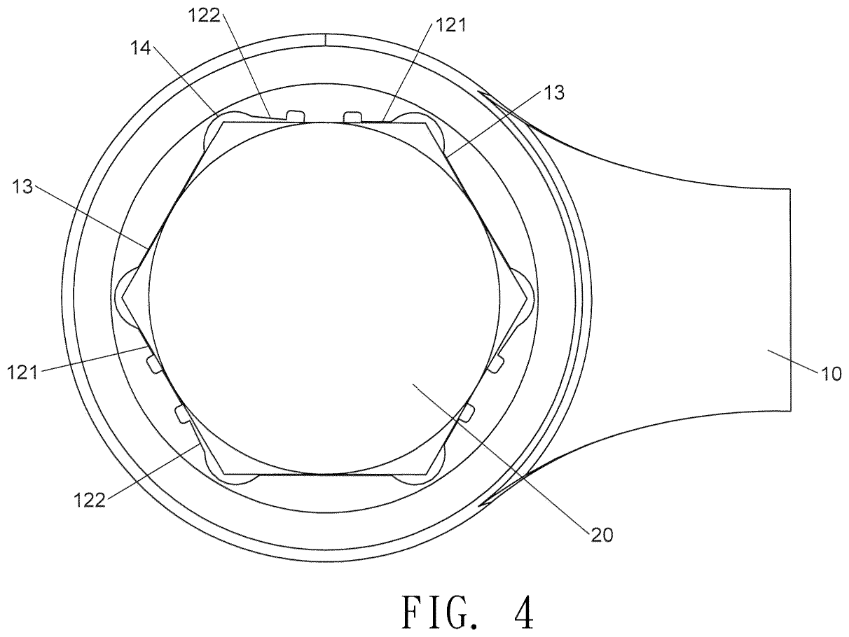

Referring to FIG. 4 with reference to FIGS. 1-3, the main body 10 is used to operate and rotate a first screw member 20 having six sides and six angled corners. When the main body 10 is rotated clockwise to drive the first screw member 20, the first faces 121 of the three first drive portions 12 press three sides of the first screw member 20, and the third faces 131 of the three second drive portions 13 press the other three sides of the first screw member 20. In addition, when the first faces 121 of the three first drive portions 12 press the three sides of the first screw member 20, an interval is defined between the second faces 122 of the three first drive portions 12 and the three sides of the first screw member 20. At the same time, each of the six angled corners of the first screw member 20 is received in one of the six receiving portions 14, so that when the mounting element 11 is rotated clockwise to drive the first screw member 20, each of the six receiving portions 14 is spaced from one of the six angled corners of the first screw member 20, to prevent the six angled corners of the first screw member 20 from being worn by the six receiving portions 14.

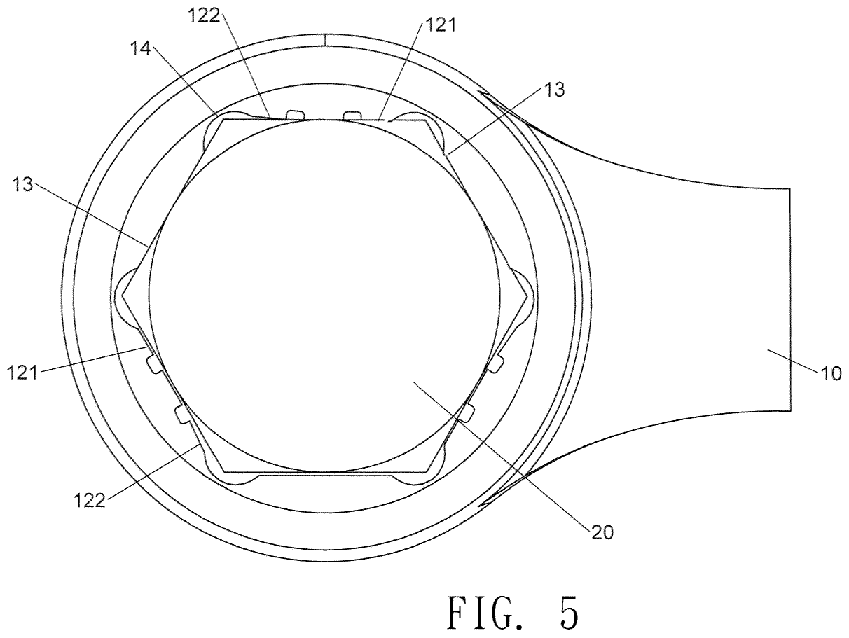

Referring to FIG. 5 with reference to FIGS. 1-3, when the main body 10 is rotated counterclockwise to drive the first screw member 20, the first screw member 20 has different tolerance, so that the second faces 122, or the first intersecting lines 123, or the third intersecting lines 1253 of the three first drive portions 12 press three sides of the first screw member 20, and the third faces 131 of the three second drive portions 13 press the other three sides of the first screw member 20. At the same time, each of the six angled corners of the first screw member 20 is received in one of the six receiving portions 14, so that when the mounting element 11 is rotated counterclockwise to drive the first screw member 20, each of the six receiving portions 14 is spaced from one of the six angled corners of the first screw member 20, to prevent the six angled corners of the first screw member 20 from being worn by the six receiving portions 14.

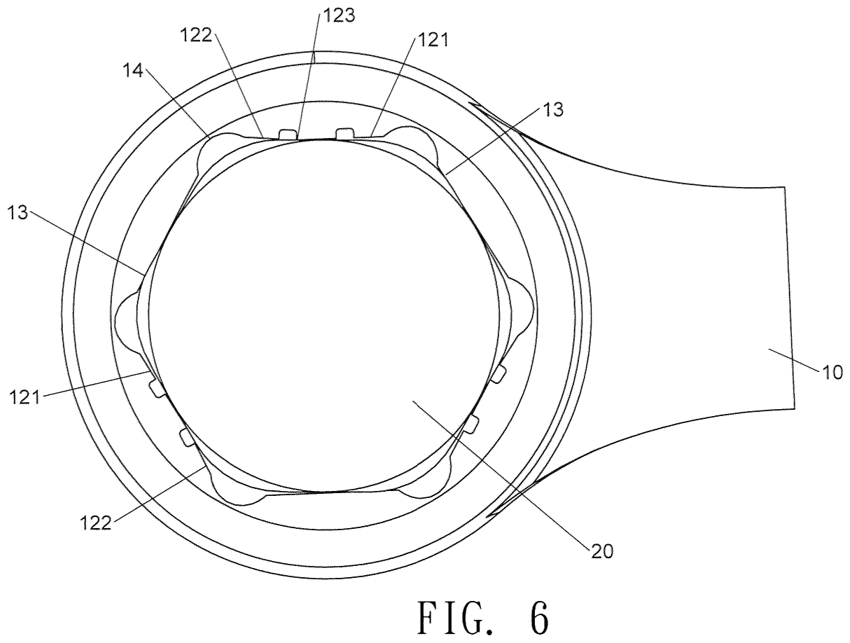

Referring to FIG. 6 with reference to FIGS. 1-3, the first screw member 20 is worn out and rounded. When the main body 10 is rotated counterclockwise to drive the first screw member 20, the first intersecting lines 123 of the three first drive portions 12 press three sides of the first screw member 20. In such a manner, the first intersecting lines 123 of the three first drive portions 12 have a line contact with the three sides of the first screw member 20, so that the first intersecting lines 123 of the three first drive portions 12 concentrate force points to drive and rotate the three worn sides of the first screw member 20 exactly and easily. Thus, the mounting element 11 is used to drive and rotate the first screw member 20 that has been worn out.

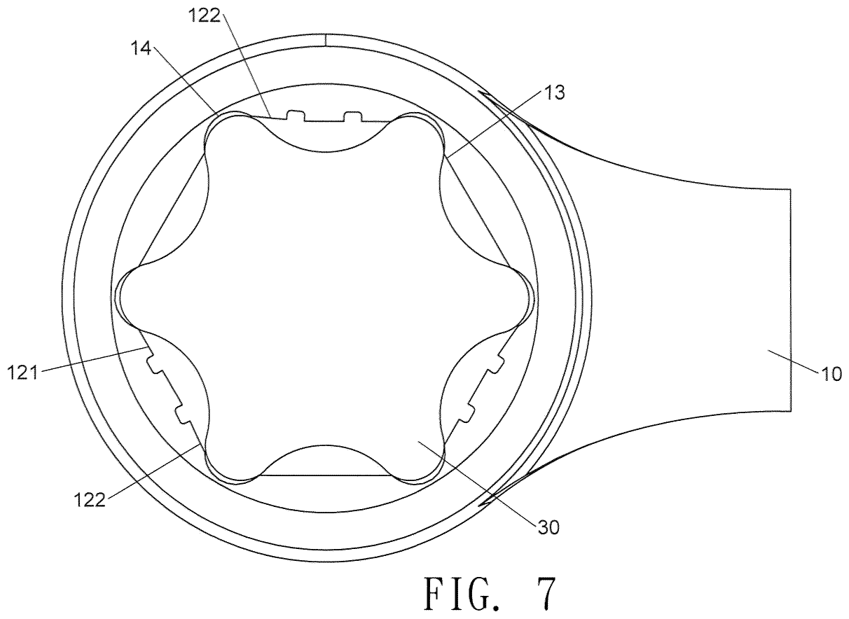

Referring to FIG. 7, the main body 10 is used to operate and rotate a second screw member 30 having six angled corners. The six angled corners of the second screw member 30 are received in the six receiving portions 14 respectively. Preferably, the second screw member 30 has a star shape.

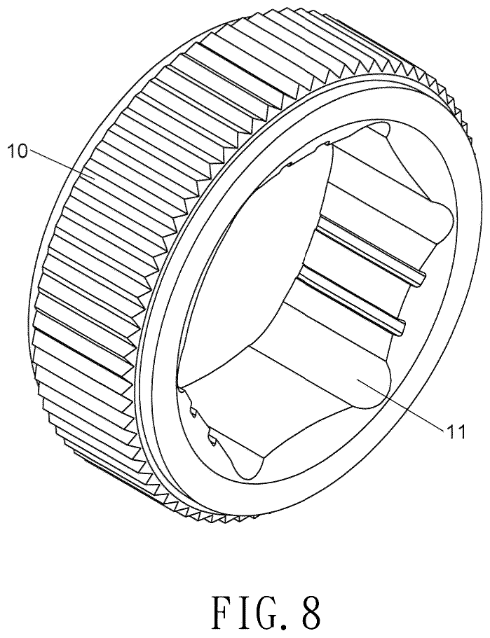

Referring to FIG. 8, the main body 10 is a ratchet wheel structure pivotally mounted on a ratchet wrench.

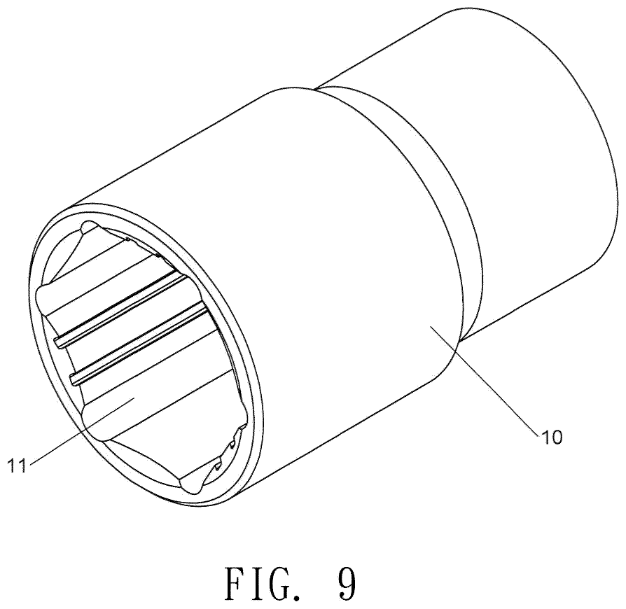

Referring to FIG. 9, the main body 10 is a socket.

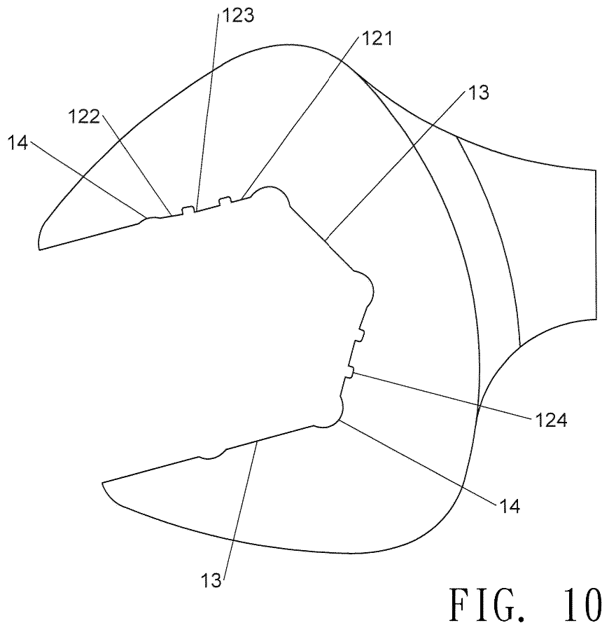

Referring to FIG. 10, the main body 10 is an open wrench having two first drive portions 12, two second drive portions 13, and five receiving portions 14. The two first drive portions 12 and the two second drive portions 13 are arranged alternately on four sides of the mounting element 11.

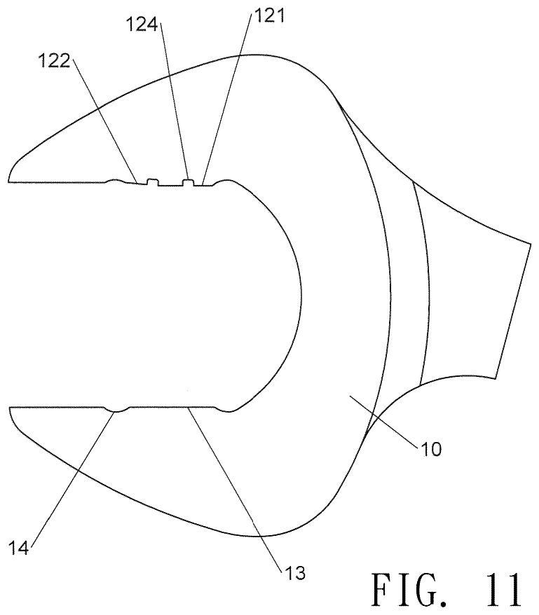

Referring to FIG. 11, the main body 10 is an open wrench having a first drive portion 12, a second drive portion 13, and two receiving portions 14. The first drive portion 12, the second drive portion 13, and the two receiving portions 14 respectively located at two opposite sides of the mounting element 11.

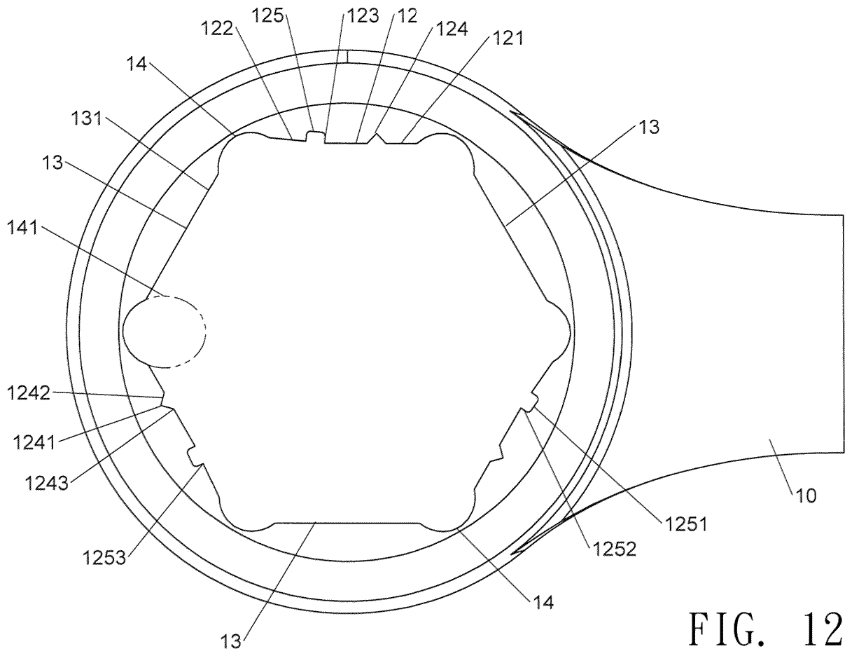

Referring to FIG. 12, the first groove 124 has a triangular shape or the first groove 124 is an isosceles triangle.

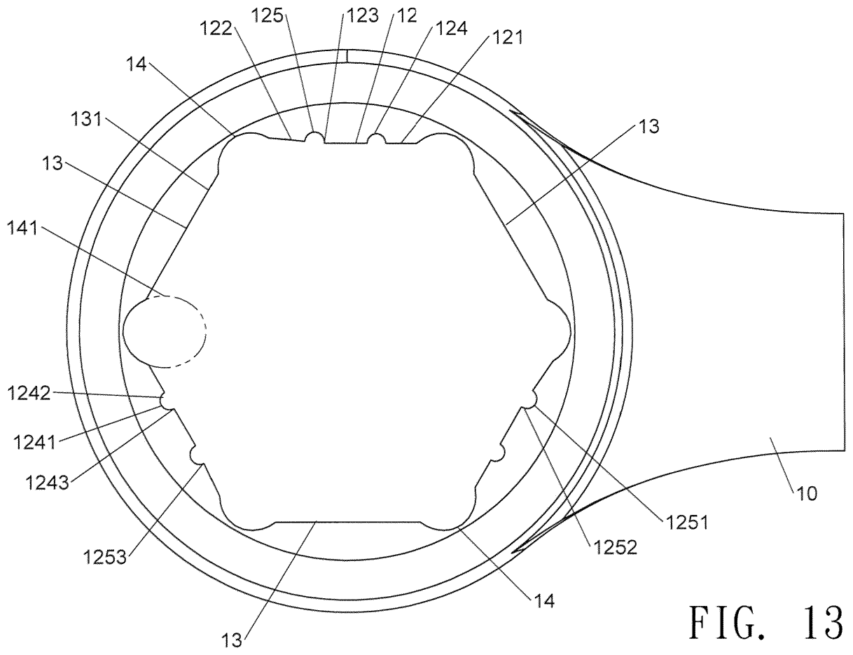

Referring to FIG. 13, the first groove 124 has a semi-circular shape, and the second groove 125 has a semi-circular shape.

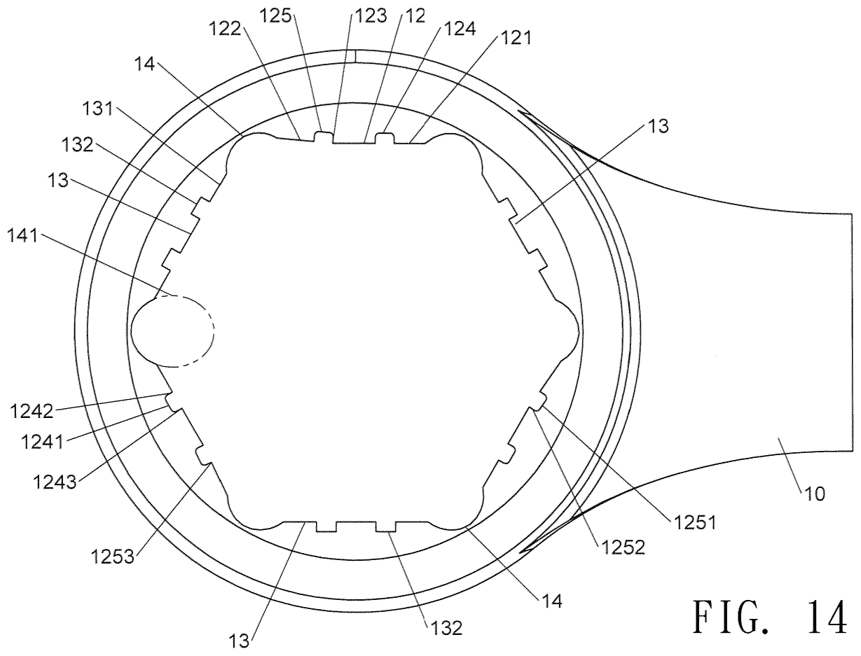

Referring to FIG. 14, each of the three second drive portions 13 is provided with two third grooves 132 spaced from each other. The two third grooves 132 are arranged symmetrically relative to the first vertical line 153.

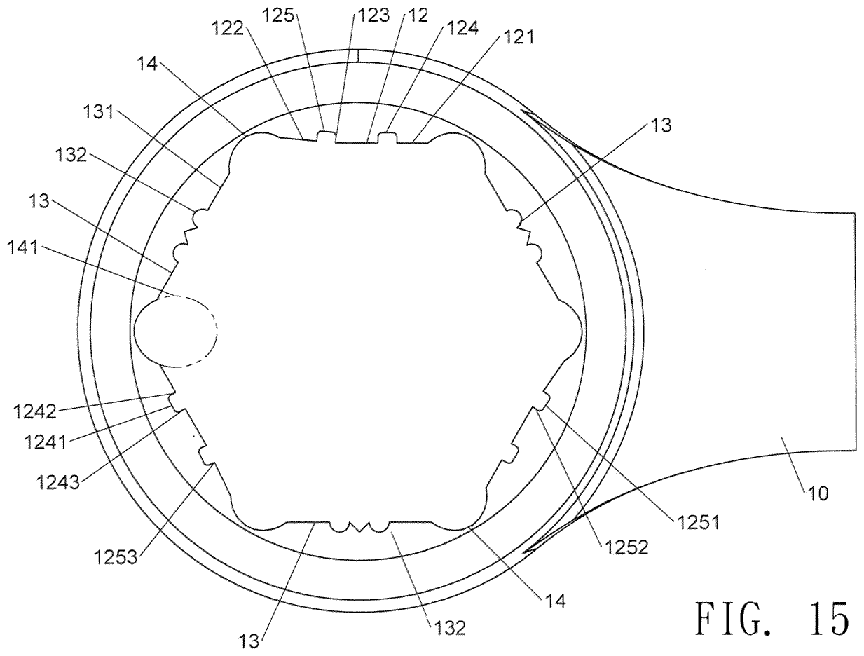

Referring to FIG. 15, each of the three second drive portions 13 is provided with three third grooves 132 having different shapes. The three third grooves 132 have a triangular shape and a semi-circular shape. The three third grooves 132 are connected.

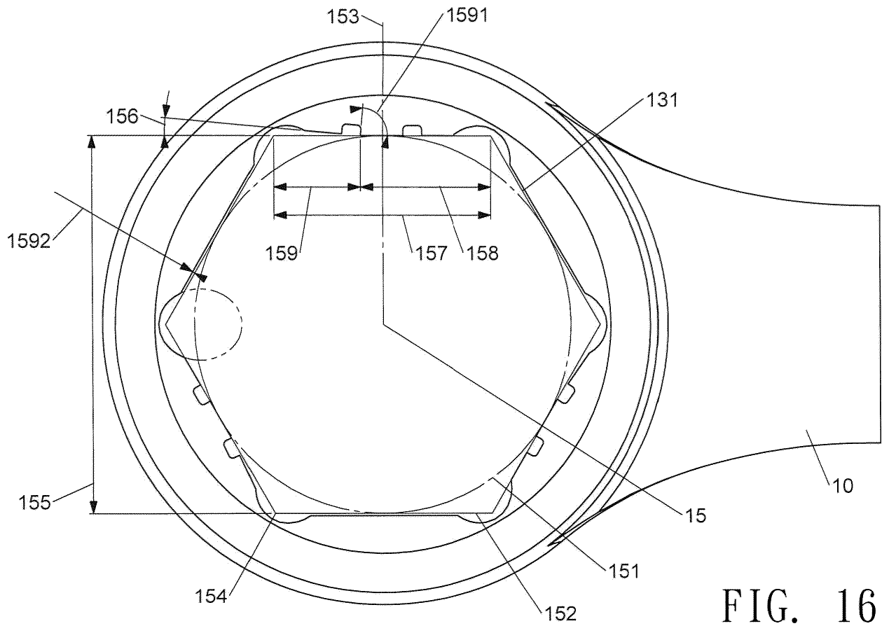

Referring to FIG. 16, the third face 131 is located outside of the first hexagon 152. The fifth distance 1592 is more than zero to provide a larger tolerance during rotation. Alternatively, the third face 131 is located inside of the first hexagon 152.

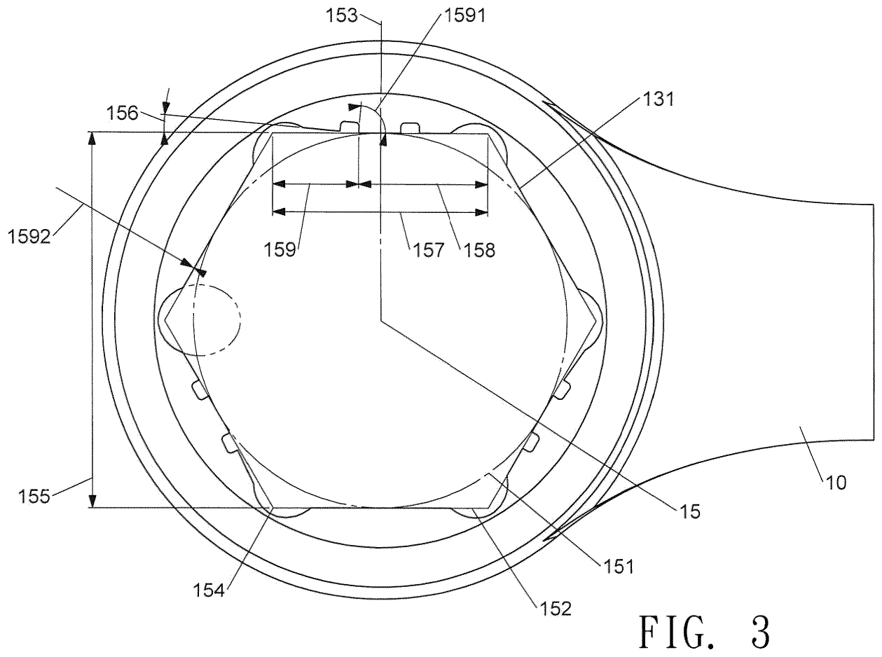

Accordingly, the engaging structure for a hand tool of the present invention has the following advantages.
1. With reference to FIG. 4, when the main body 10 is rotated clockwise to drive the first screw member 20, the first faces 121 of the three first drive portions 12 press three sides of the first screw member 20 to provide a primary driving force, so that the first faces 121 of the three first drive portions 12 have the maximum contact area for driving the first screw member 20. In addition, the third faces 131 of the three second drive portions 13 the other three sides of the first screw member 20 to provide a secondary driving force, so that the third faces 131 of the three second drive portions 13 have a larger contact area for driving the first screw member 20. Thus, the main body 10 provides a primary driving force and a secondary driving force, to prevent the six sides of the first screw member 20 from being worn out when the main body 10 is driven to rotate the first screw member 20.
2. With reference to FIG. 5, when the main body 10 is rotated counterclockwise to drive the first screw member 20, the second faces 122, or the first intersecting lines 123, or the third intersecting lines 1253 of the three first drive portions 12 press three sides of the first screw member 20 to provide a primary driving force, and the third faces 131 of the three second drive portions 13 press the other three sides of the first screw member 20 to provide a secondary driving force. Thus, the main body 10 provides a primary driving force and a secondary driving force, to prevent the six sides of the first screw member 20 from being worn out when the main body 10 is driven to rotate the first screw member 20.
3. With reference to FIG. 6, when the main body 10 is rotated to drive the first screw member 20 whose six sides are worn out and rounded, the first intersecting lines 123 of the three first drive portions 12 press and lock the three small sides of the first screw member 20. In such a manner, the first intersecting lines 123 of the three first drive portions 12 focus the force points to drive and rotate the three worn sides of the first screw member 20 exactly and easily. At this time, with reference to FIG. 3, the first intersecting line 123 is very close to the first vertical line 153. Thus, by provision of the first intersecting lines 123 of the three first drive portions 12, the mounting element 11 is used to drive and rotate the first screw member 20 that has been worn out seriously.
4. When the main body 10 is rotated clockwise to drive the first screw member 20, the main body 10 provides a primary driving force and a secondary driving force. When the main body 10 is rotated counterclockwise to drive the first screw member 20, the main body 10 also provides a primary driving force and a secondary driving force. When the main body 10 is rotated to drive the first screw member 20 whose six sides are worn out and rounded, the first intersecting lines 123 of the three first drive portions 12 lock the three sides of the first screw member 20 to provide a force concentration, so that the mounting element 11 is used to drive and rotate the first screw member 20 that has been worn out. Thus, the mounting element 11 has three rotational modes to drive and rotate the first screw member 20 exactly.
5. Each of the first face 121, the second face 122, and the third face 131 has a planar shape, so that the first face 121, the second face 122, and the third face 131 will not cause a bite mark (or serration) on the first screw member 20 during rotation.
6. Each of the three second drive portions 13 has a traditional structure. Thus, the three first drive portions 12 are added to cooperate with the three second drive portions 13 to facilitate operation of the mounting element 11.
7. Each of the three first drive portions 12 and each of the three second drive portions 13 have different structures. The first face 121 coincides with each of the six sides of the first hexagon 152. The fifth distance 1592 is defined between the third face 131 and one of the six sides of the first hexagon 152. In general, for the first screw member 20 with a specification 19, the upper limit is about 18.97 mm, and the lower limit is about 18.50 mm. Thus, the three first drive portions 12 and the three second drive portions 13 have different structures to satisfy the first screw member 20 with more different tolerance and to provide better rotational effect.
8. The third face 131 is located outside of the first hexagon 152. Thus, if the first screw member 20 approaches the upper limit of 18.97 mm, the second face 122 is able to rotate the first screw member 20 when the main body 10 is rotated counterclockwise to drive the first screw member 20.
9. With reference to FIG. 3, the second angle 1591 defined between the first face 121 and one of the two fourth sides 1252 is less than 180°. When the second angle 1591 is acute, the first intersecting lines 123 of the three first drive portions 12 have a more force concentration, so that the mounting element 11 is used to drive and rotate the first screw member 20 that has been worn out.
10. Each of the six receiving portions 14 has an arcuate concave shape so that when the main body 10 is rotated to drive the first screw member 20, each of the six angled corners of the first screw member 20 is disposed in each of the six receiving portions 14, thereby preventing each of the six angled corners of the first screw member 20 from being worn out.
11. Each of the six receiving portions 14 has an arcuate concave shape and is formed with a first ellipse 141, and the main body 10 is used to mount and rotate the second screw member 30. Thus, the mounting element 11 is able to rotate the first screw member 20 and the second screw member 30 to enhance the utility of the main body 10.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An engaging structure for a hand tool comprising:
a main body;
wherein:
the main body is provided with a mounting element;
the mounting element includes three first drive portions, three second drive portions, and six receiving portions;
the three first drive portions and the three second drive portions are arranged alternately and annularly;
each of the six receiving portions is arranged between one of the three first drive portions and one of the three second drive portions;
each of the three first drive portions includes a first face and a second face;
the first face has a planar shape;
the second face has a planar shape;
the first face and the second face have an intersection provided with a first intersecting line;
the first face and the second face intersect at a straight line;
each of the three first drive portions is provided with a first groove disposed on the first face;
the first groove has a first side and two second sides;
the first side and the two second sides form a U-shaped opening;
each of the first side has a planar shape;
each of the two second sides has a planar shape;
the first side is provided on a bottom of the first groove;
the two second sides are at two sides of the first side;
the first groove and the first face have an intersection provided with two second intersecting lines;
the two second intersecting lines are parallel with each other;
the two second intersecting lines are parallel with the first intersecting line;
each of the three first drive portions is provided with a second groove disposed on the second face;
the second groove has a third side and two fourth sides;
the third side and the two fourth sides form a U-shaped opening;
each of the third side has a planar shape;
each of the two fourth sides has a planar shape;
the third side is provided on a bottom of the second groove;
the two fourth sides are at two sides of the third side;
one of the two fourth sides coincides with the first intersecting line;
the second groove and the second face have an intersection provided with a third intersecting line;
the second groove and each of the three first drive portions intersect at the first intersecting line and the third intersecting line;
the third intersecting line is parallel with the first intersecting line;
the third intersecting line is parallel with each of the two second intersecting lines;
the second groove has a shape and a structure the same as that of the first groove;
an interval is defined between the second groove and the first groove;
the third side has a size equal to that of the first side;
each of the two fourth sides has a size equal to that of each of the two second sides;
each of the three second drive portions is provided with a third face having a planar shape;
each of the six receiving portions is an arcuate concave face;
in a two-dimensional view, the mounting element has an axis provided with a first center which constructs a first circle;
the first face of each of the three first drive portions is tangent to the first circle;
the first circle forms a first hexagon having six sides;
the first face of each of the three first drive portions coincides with one of the six sides of the first hexagon;
the first center is provided with a first vertical line;
the first face of one of the three first drive portions is perpendicular to the first vertical line;
the first face of one of the three first drive portions intersects the first vertical line and is located on two sides of the first vertical line respectively;
the first groove is arranged at a first side of the first vertical line;
the second face, the first intersecting line, the third intersecting line, and the second groove are arranged at a second side of the first vertical line;
the first hexagon has six first angled corners;
each of the six receiving portions is situated outside of one of the six first angled corners;
a first distance is defined between two of the six sides of the first hexagon;
a first angle is defined between the second face and the first face;
each of the six sides of the first hexagon defines a second distance;
a third distance is defined between the first intersecting line and one of the six first angled corners;
a fourth distance is defined between the first intersecting line and another one of the six first angled corners;
the third distance plus the fourth distance is equal to the second distance;
a second angle is defined between the first face and one of the two fourth sides; and
a fifth distance is defined between the third face and one of the six sides of the first hexagon.

2. The engaging structure for a hand tool as claimed in claim 1, wherein:
the main body is a box end wrench or an engaging member of a hand operated tool; or
the main body is a ratchet wheel structure pivotally mounted on a ratchet wrench; or
the main body is a socket; or
the main body is an open wrench having two first drive portions, two second drive portions, and five receiving portions, and the two first drive portions and the two second drive portions are arranged alternately on four sides of the mounting element; or
the main body is an open wrench having a first drive portion, a second drive portion, and two receiving portions, and the first drive portion, the second drive portion, and the two receiving portions respectively located at two opposite sides of the mounting element.

3. The engaging structure for a hand tool as claimed in claim 1, wherein:
each of the six receiving portions is formed with a first ellipse; and
each of the six receiving portions is not tangent to the first face, the second face, and the third face.

4. The engaging structure for a hand tool as claimed in claim 1, wherein:
the first angle is less than 15° or the first angle is ranged between 5° and 10°;
a ratio of the third distance and the fourth distance is 6:4 or close to 6:4;
the second angle is less than 180°; and
the fifth distance is equal to zero so that the third face coincides with one of the six sides of the first hexagon.

5. The engaging structure for a hand tool as claimed in claim 1, wherein:
the main body is used to operate and rotate a first screw member having six sides and six angled corners;
when the main body is rotated clockwise to drive the first screw member, the first faces of the three first drive portions press three sides of the first screw member, and the third faces of the three second drive portions press the other three sides of the first screw member;
when the first faces of the three first drive portions press the three sides of the first screw member, an interval is defined between the second faces of the three first drive portions and the three sides of the first screw member;
each of the six angled corners of the first screw member is received in one of the six receiving portions, so that when the mounting element is rotated clockwise to drive the first screw member, each of the six receiving portions is spaced from one of the six angled corners of the first screw member, to prevent the six angled corners of the first screw member from being worn by the six receiving portions;
when the main body is rotated counterclockwise to drive the first screw member, the first screw member has different tolerance, so that the second faces, or the first intersecting lines, or the third intersecting lines of the three first drive portions press three sides of the first screw member, and the third faces of the three second drive portions press the other three sides of the first screw member;
each of the six angled corners of the first screw member is received in one of the six receiving portions, so that when the mounting element is rotated counterclockwise to drive the first screw member, each of the six receiving portions is spaced from one of the six angled corners of the first screw member, to prevent the six angled corners of the first screw member from being worn by the six receiving portions;
the first screw member is worn out and rounded;
when the main body is rotated counterclockwise to drive the first screw member, the first intersecting lines of the three first drive portions press three sides of the first screw member;
the first intersecting lines of the three first drive portions have a line contact with the three sides of the first screw member, so that the first intersecting lines of the three first drive portions concentrate force points to drive and rotate the three worn sides of the first screw member;
the mounting element is used to drive and rotate the first screw member that has been worn out.

6. The engaging structure for a hand tool as claimed in claim 1, wherein:
the main body is used to operate and rotate a second screw member having six angled corners;
the six angled corners of the second screw member are received in the six receiving portions respectively; and
the second screw member has a star shape.

7. The engaging structure for a hand tool as claimed in claim 1, wherein:
the first groove has a triangular shape; or
the first groove is an isosceles triangle; or
the first groove has a semi-circular shape, and the second groove has a semi-circular shape.

8. The engaging structure for a hand tool as claimed in claim 1, wherein the each of the three second drive portions is provided with two third grooves spaced from each other, and the two third grooves are arranged symmetrically relative to the first vertical line.

9. The engaging structure for a hand tool as claimed in claim 1, wherein:
the each of the three second drive portions is provided with three third grooves having different shapes;
the three third grooves have a triangular shape and a semi-circular shape; and
the three third grooves are connected.

10. The engaging structure for a hand tool as claimed in claim 1, wherein:
the third face is located outside of the first hexagon;
the fifth distance is more than zero to provide a larger tolerance during rotation; or
the third face is located inside of the first hexagon.
